(19) United States
(12) Patent Application Publication
(10) Pub. No.: US 2013/0316712 A1
(43) Pub. Date: Nov. 28, 2013

(54) METHOD AND APPARATUS FOR PERFORMING HANDOVER IN WIRELESS COMMUNICATION SYSTEM

(71) Applicants: Jaewook Lee, Anyang-si (KR); Seungjune Yi, Anyang-si (KR); Youngdae Lee, Anyang-si (KR); Sungjun Park, Anyang-si (KR); Sunghoon Jung, Anyang-si (KR); Sangwon Kim, Anyang-si (KR)

(72) Inventors: Jaewook Lee, Anyang-si (KR); Seungjune Yi, Anyang-si (KR); Youngdae Lee, Anyang-si (KR); Sungjun Park, Anyang-si (KR); Sunghoon Jung, Anyang-si (KR); Sangwon Kim, Anyang-si (KR)

(73) Assignee: LG ELECTRONICS INC., Seoul (KR)

(21) Appl. No.: 13/984,521

(22) PCT Filed: Mar. 6, 2012
(86) PCT No.: PCT/KR12/01636

§ 371 Date: Aug. 8, 2013

Related U.S. Application Data
(60) Provisional application No. 61/452,151, filed on Mar. 13, 2011.

(51) Int. Cl. H04W 36/00

(52) U.S. Cl. CPC H04W 36/00
USPC 455/436

(57) ABSTRACT

The present invention relates to a method of performing a handover of a mobile device by a first base station. The present invention includes transmitting a handover request message to a second base station, receiving a handover response message in response to the handover request message from the second base station, wherein the handover response message includes subframe configuration information related to the second base station, and performing the handover of the mobile device based on the received handover response message.

### TECHNICAL FIELD

The present invention relates to a wireless communication system, and more particularly, to a method and apparatus for performing handover.

### BACKGROUND ART

A wireless communication system has been widely developed to provide various types of communication services such as voice and data. Generally, the wireless communication system refers to a multiple access system which can support communication with multiple users by sharing available system resources (bandwidth, transmission power, etc.). The multiple access system includes a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier-Frequency Division Multiple Access (SC-FDMA) system, and a Multi Carrier-Frequency Division Multiple Access (MC-FDMA) system.

### DISCLOSURE OF INVENTION

### Technical Problem

The present invention provides a method and apparatus for performing efficient handover in a wireless communication system.

It will be appreciated by persons skilled in the art that that the technical objects to be achieved by the present invention are not limited to what has been particularly described hereinabove and other technical objects not mentioned above will be more clearly understood from the following detailed description.

### Solution To Problem

The object of the present invention can be achieved by providing a method of performing a handover of a mobile device by a first base station, including transmitting a handover request message to a second base station, receiving a handover response message in response to the handover request message from the second base station, the handover response message including subframe configuration information related to the second base station, and performing the handover of the mobile device based on the received handover response message.

The handover request message may include subframe configuration information related to the first base station, and the subframe configuration information related to the second base station may be determined according to the subframe configuration information related to the first base station.

The subframe configuration information related to the second base station may be used by the mobile device in the second base station.

The subframe configuration information related to the first base station may be used by the mobile device in the first base station.

The mobile device may be a mobile relay node (RN).

The subframe configuration information may be RN subframe configuration information.

The RN subframe configuration information may include information on a number of RN subframes and information on a subframe number of the RN subframes.

In another aspect of the present invention, provided herein is an apparatus for performing a handover of a mobile device, including a transmitter, a receiver, and a processor configured to control the transmitter to transmit a handover request message to a base station, configured to control the receiver to receive a handover response message in response to the handover request message from the base station, the handover response message including subframe configuration information related to the base station, and configured to perform the handover of the mobile device based on the received handover response message.

The handover request message may include subframe configuration information related to the apparatus, and the subframe configuration information related to the base station may be determined according to the subframe configuration information related to the apparatus.

The subframe configuration information related to the base station may be used by the mobile device in the base station.

The subframe configuration information related to the apparatus may be used by the mobile device in the apparatus.

The mobile device may be a mobile relay node (RN).

The subframe configuration information may be RN subframe configuration information.

The RN subframe configuration information may include information on a number of RN subframes and information on a subframe number of the RN subframes.

In a further aspect of the present invention, provided herein is a method of performing a handover by a mobile device, including receiving a message including subframe configuration information used in a target base station from a serving base station, and performing a random access procedure with the target base station using the received subframe configuration information.

In still another aspect of the present invention, provided herein is an apparatus for performing a handover, including a transmitter, a receiver, and a processor configured to control the receiver to receive a message including subframe configuration information used in a target base station from a serving base station, and configured to perform a random access procedure with the target base station using the received subframe configuration information.

### Advantageous Effects of Invention

According to embodiments of the present invention, since a mobile device quickly acquires information about a radio frame of a corresponding cell from a target base station, execution of efficient and optimized handover can be guaranteed.

It will be appreciated by persons skilled in the art that that the effects that can be achieved through the present invention are not limited to what has been particularly described hereinabove and other advantages not mentioned above will be more clearly understood from the following detailed description.

### BRIEF DESCRIPTION OF DRAWINGS

The accompanying drawings, which are included to provide a further understanding of the invention, illustrate embodiments of the invention and together with the description serve to explain the principle of the invention.

In the drawings:

FIG. 1 illustrates the structure of an Evolved Universal Mobile Telecommunications System (E-UMTS);

FIGS. 2 and 3 illustrate the structures of a radio interface protocol between a UE and an E-UTRAN based on the 3GPP radio access network standard to which the present invention is applied;

FIG. 4 illustrates a Relay Node (RN) and Un and Uu interfaces to which the present invention is applied;

FIG. 5 illustrates the structure of a downlink radio frame to which the present invention is applied;

FIG. 6 illustrates an example of using a mobile RN;

FIG. 7 illustrates a handover process of a mobile RN according to an exemplary embodiment of the present invention;

FIG. 8 illustrates a handover process of a mobile RN according to another exemplary embodiment of the present invention; and

FIG. 9 illustrates the configuration of a mobile device and a base station to which the present invention is applied.

### BEST MODE FOR CARRYING OUT THE INVENTION

Reference will now be made in detail to the exemplary embodiments of the present invention with reference to the accompanying drawings. The detailed description, which will be given below with reference to the accompanying drawings, is intended to explain exemplary embodiments of the present invention, rather than to show the only embodiments that can be implemented according to the invention.

The following detailed description includes specific details in order to provide a thorough understanding of the present invention. However, it will be apparent to those skilled in the art that the present invention may be practiced without such specific details. Techniques, apparatuses, and systems, which will be described hereinbelow, are applicable to various wireless multiple access systems. For convenience of description, description will be given under the assumption that the present invention is applied to 3GPP LTE/LTE-A systems. However, the technical features of the present invention are not limited thereto. For example, although the following detailed description is given based on wireless communication systems corresponding to 3GPP LTE/LTE-A systems, it is applicable to other wireless communication systems except for matters that are specific to 3GPP LTE/LTE-systems.

In some instances, known structures and devices are omitted or are shown in block diagram form, focusing on important features of the structures and devices, so as not to obscure the concept of the present invention. The same reference numbers will be used throughout this specification to refer to the same or like parts.

In the present invention, a User Equipment (UE) may be fixed or mobile and refers to a device that transmits and receives data and control information while communicating with a base station. The UE may be referred to as a Mobile Station (MS), a Mobile Terminal (MT), a User Terminal (UT), a Subscriber Station (SS), a wireless device, a Personal Digital Assistant (PDA), a wireless modem, or a handheld device.

In addition, a Base Station (BS) generally refers to a fixed station communicating with UEs or other BSs and exchanges data and control information with UEs and other BSs. The BS may be referred to as other terms such as an evolved-NodeB (eNB), a Base Transceiver System (BTS), an Advanced Base Station (ABS), a Processing Server (PS), a Radio Remote Header (RRH), and an Access Point (AP).

First, a 3GPP LTE system is described as an exemplary wireless communication system to which the present invention is applied.

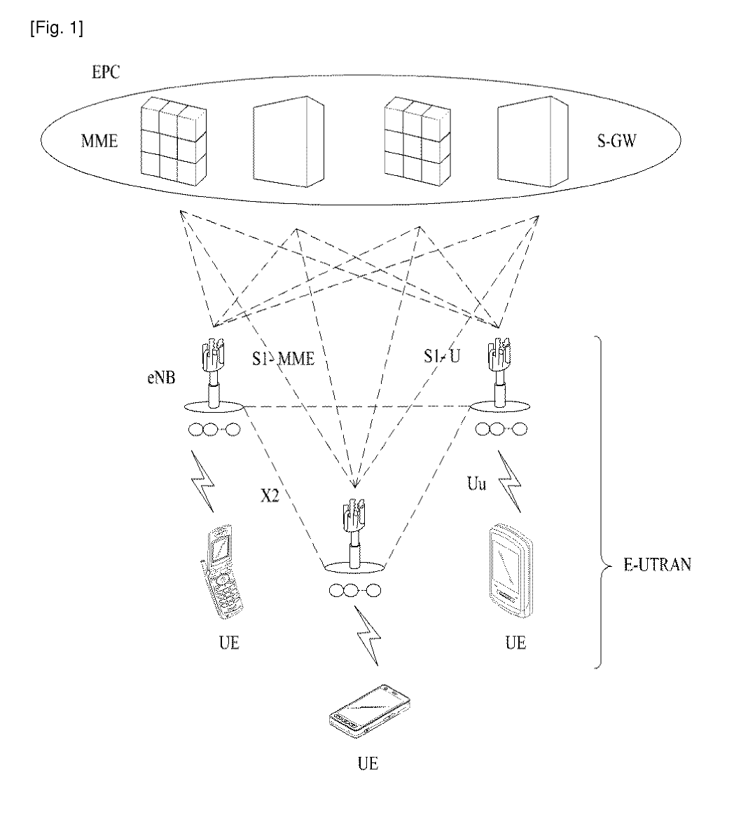

FIG. 1 illustrates the structure of an Evolved Universal Mobile Telecommunications System (E-UMTS). E-UMTS is an advanced version of a conventional Universal Mobile Telecommunications System (UMTS) and standardization thereof is currently underway in the 3GPP. E-UMTS is called a Long Term Evolution (LTE) system. E-UMTS may be divided into an Evolved Terrestrial Radio Access Network (E-UTRAN) and an Evolved Packet Core (EPC).

E-UMTS includes UEs and eNBs. The eNBs are connected to each other by wire through an X2 interface and the eNB and the UE are wirelessly connected to each other through a Uu interface.

The EPC may include a Mobility Management Entity (MME) in charge of a control plane function, a Serving-Gateway (S-GW) in charge of a user plane, and a Packet Data Network-Gateway (PDN-GW). The connection between the eNB and the MME is called an S1-MME interface, the connection between the eNB and the S-GW is called an S1-U interface, and both connections may be commonly called an S1 interface.

The MME has information on the connection of the UE or the capabilities of the UE, and such information is primarily used for mobility management of the UE. The S-GW is a gateway having E-UTRAN as an end point, and the PDN-GW is a gateway having PDN as an end point.

A control message exchanged between the eNBs through the X2 interface uses an X2 Application Part (X2AP) protocol and is called an X2AP message. A control message exchanged between the MME and the eNB through the S1 interface uses an S1 Application Part (S1AP) protocol and is called an S1AP message.

The Uu interface, which is a radio section, uses a radio interface protocol. The radio interface protocol may be divided into L1 (a first layer) including a physical layer, L2 (a second layer) including MAC/RLC/PDCP layers, and L3 (a third layer) including an RRC layer, based on three lower layers of the Open Systems Interconnection (OSI) reference model widely known in communications systems.

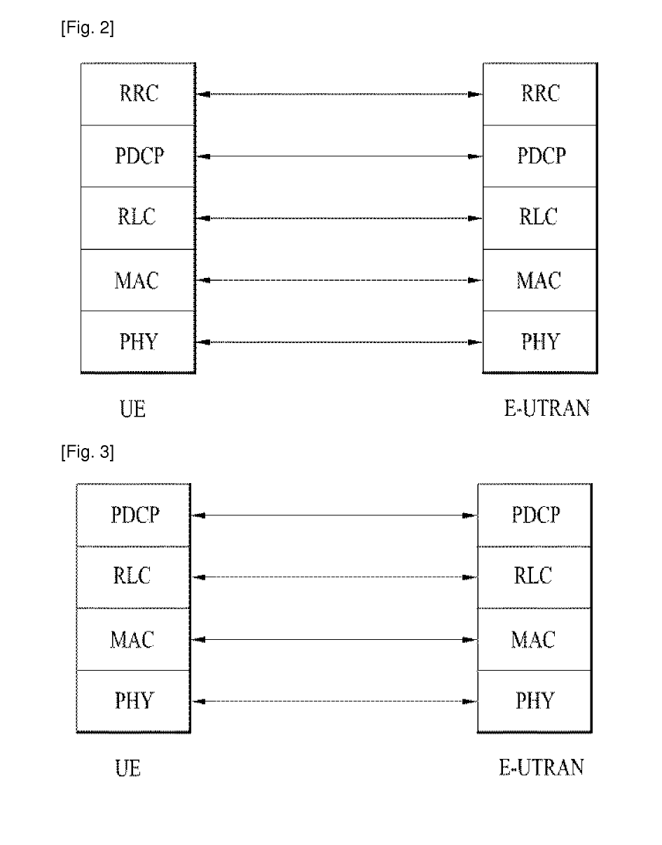

FIGS. 2 and 3 illustrate the structures of a radio interface protocol between a UE and an E-UTRAN based on the 3GPP radio access network standard to which the present invention is applied. The radio interface protocol horizontally includes a physical layer, a data link layer, and a network layer, and is vertically divided into a user plane (U-plane) for transmitting data information and a control plane (C-plane) for transferring control signals.

The protocol layers shown in FIGS. 2 and 3 can be divided into L1 (a first layer), L2 (a second layer), and L3 (a third layer), based on three lower layers of an Open Systems Interconnection (OSI) reference model widely known in communications systems. Those radio protocol layers exist as a pair in the UE and the E-UTRAN to perform data transmission for a radio section. Hereinafter, each layer of the control plane of the radio protocol of FIG. 2 and the user plane of the radio protocol of FIG. 3 will be described in detail.

A physical layer belonging to the first layer provides information transfer services to an upper layer using a physical channel. The physical layer is connected to a Medium Access Control (MAC) layer located at an upper layer thereof, via a transport channel, and data is transferred between the MAC layer and the physical layer via the transport channel. The transport channel can be divided into a dedicated transport channel and a common transport channel according to whether the channel is shared. Data is transferred via a physical channel between different physical layers, in other words, between the physical layer of a transmitting side and the physical layer of a receiving side. The physical channel is modulated by an Orthogonal Frequency Division Multiplexing (OFDM) scheme and time and frequency are used as radio resources for physical the channel.

The second layer includes a variety of layers. First, the MAC layer serves various logical channels to various transport channels. In addition, the MAC layer performs logical channel multiplexing to map multiple logical channels to one transport channel. The MAC layer is connected to a Radio Link Control (RLC) layer which is an upper layer thereof, via a logical channel. The logical channel is broadly divided into a control channel for transferring information of the control plane and a traffic channel for transferring information of the user plane, according to a type of information transferred.

The RLC layer of the second layer segments and concatenates data received from an upper layer to adjust a data size so that a lower layer can transfer data to a radio section. Also, the RLC layer provides three operation modes such as a Transparent Mode (TM), an Un-acknowledged Mode (UM), and an Acknowledged Mode (AM) so as to guarantee various Quality of Service (QoS) required by each Radio Bearer (RB). In particular, an AM RLC layer performs a retransmission function through an Automatic Repeat and Request (ARQ) function for reliable data transmission.

A Packet Data Convergence Protocol (PDCP) layer of the second layer performs a header compression function for reducing the size of an IP packet header, which is relatively large in size and contains unnecessary control information, in order to efficiently transmit an IP packet, such as an IPv4 or IPv6 packet, in a radio section with a relatively small bandwidth. Due to this, only necessarily required information in the header portion of data is transmitted, thereby serving to increase the transmission efficiency of the radio section. In addition, in an LTE system, the PDCP layer performs a security function which includes ciphering for preventing the third party data wiretapping and integrity protection for preventing the third party data manipulation.

A Radio Resource Control (RRC) layer located at the uppermost portion of the third layer is defined only in the control plane. The RRC layer performs control of logical channels, transport channels, and physical channels in relation to configuration, reconfiguration, and release of RBs. The RB denotes a service provided by the second layer to transfer data between the UE and the E-UTRAN. If an RRC connection is present between the RRC layer of the UE and the RRC layer of the E-UTRAN, the UE is in an RRC_CONNECTED state and, otherwise, the UE is in an RRC_IDLE state.

Hereinafter, an RRC state and an RRC connection method of the UE will be described in more detail. The RRC state refers to whether or not the RRC of the UE is logically connected to the RRC of an E-UTRAN. If connected, then it is called an RRC_CONNECTED state, and otherwise it is called an RRC_IDLE state. For the UE in an RRC_CONNECTED state, the E-UTRAN can recognize the existence of the relevant UE in a cell unit because there exists an RRC connection thereof, and thus the E-UTRAN can effectively control the UE. On the contrary, for the UE in an RRC_IDLE state, the E-UTRAN cannot recognize the relevant UE, and therefore, it is managed by an EPC in a Tracking Area (TA) unit, which is an area unit larger than a cell. In other words, the existence of the UE in an RRC_IDLE state is only recognized in a large area unit, and therefore, the UE should be changed to an RRC_CONNECTED state in order to receive typical mobile communication services such as voice or data.

When the UE is initially turned on by a user, the UE first searches for a suitable cell and then is camped in an RRC_IDLE state in the relevant cell. The UE camped in an RRC_IDLE state makes an RRC connection with the RRC of the E-UTRAN through an RRC connection configuration procedure when it is required to make an RRC connection and then transitions to an RRC_CONNECTED state. There are several cases when the UE in an RRC_IDLE state is required to make an RRC connection. For example, uplink data transmission may be required due to a phone call attempt by the user, or the transmission of a response message may be required in response to a paging message received from the E-UTRAN.

Meanwhile, downlink transport channels for transmitting data to the UE from a network includes a Broadcast Channel (BCH) for transmitting system information and a Shared Channel (SCH) for transmitting user traffic or control messages. Traffic or control messages of a downlink multicast or broadcast service may be transmitted through the downlink SCH or may be transmitted through an additional downlink Multicast Channel (MCH). Uplink transport channels for data transmission from the UE to the network include a Random Access Channel (RACH) for transmitting initial control messages and an uplink SCH for transmitting user traffic or control messages. Logical channels, which are located at an upper level of the transport channels and are mapped to the transport channels, include a Broadcast Control Channel (BCCH), a Paging Control Channel (PCCH), a Common Control Channel (CCCH), a Multicast Control Channel (MCCH), and a Multicast Traffic Channel (MTCH).

A physical channel includes multiple subframes arranged on a time axis and multiple subcarriers arranged on a frequency axis. Here, a subframe includes a plurality of symbols on the time axis. A subframe includes a plurality of resource blocks each including a plurality of symbols and a plurality of subcarriers. Also, each subframe may use particular subcarriers of particular symbols (e.g., a first symbol) in the relevant subframe for a Physical Downlink Control Channel (PDCCH), that is, an L1/L2 control channel. A subframe has a time duration of 0.5 ms. A Transmission Time Interval (TTI) as a unit time for transmitting data is 1 ms corresponding to two subframes.

On the other hand, a relay process has been introduced to smoothly perform communication when a UE and an eNB are far away, as a technique for relaying data between the UE and the eNB. To carry out such a relay process, a Relay Node (RN), which is a new wireless device, is introduced between the UE and the eNB, and an eNB for managing the RN may be called a Donor eNB (DeNB) to distinguish it from a typical eNB. Also, an interface between the RN and the eNB is defined as a Un interface which is distinguished from a Uu interface between the UE and the eNB.

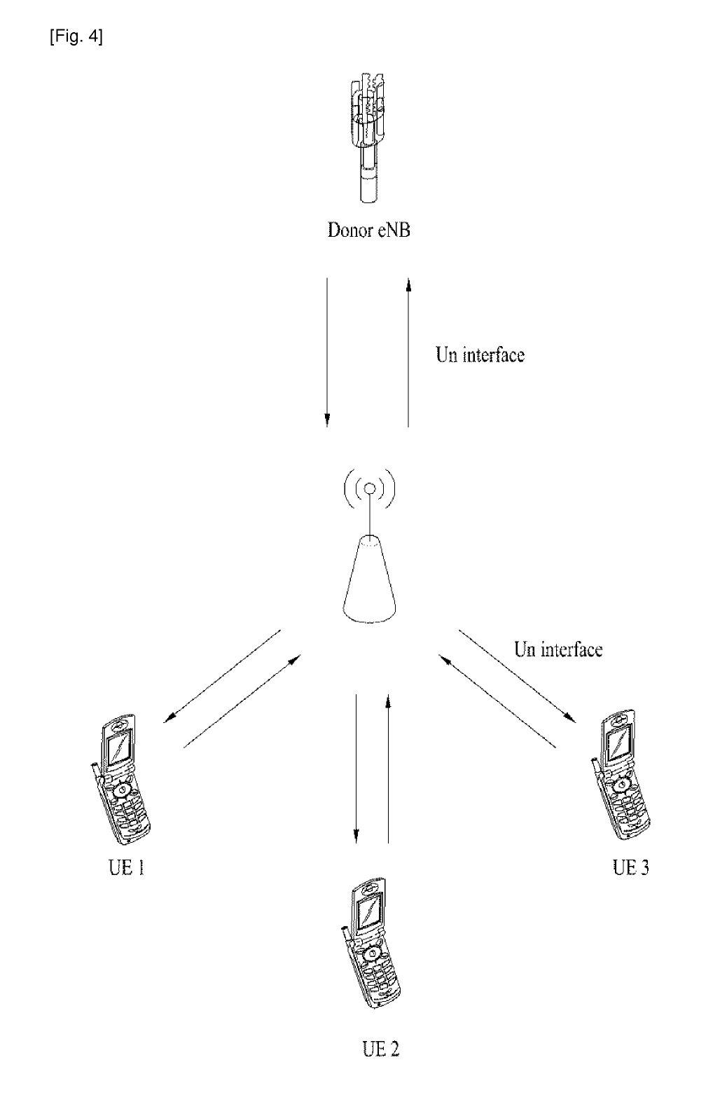

FIG. 4 illustrates an RN and Un and Uu interfaces to which the present invention is applied. Referring to FIG. 4, the RN replaces an eNB to serve to manage UEs. In other words, the RN seems to be the eNB in terms of the UEs. Accordingly, the Uu interface which is the same as an interface between the eNB and UEs is applied between the RN and the UEs, and MAC/RLC/PDCP/RRC of a radio interface protocol are used.

In terms of the eNB, the RN may seem to be a UE or another eNB according to circumstances. Namely, when the RN first accesses the eNB, since the eNB does not know the existence of the RN, the eNB is connected to the RN through random access as if the eNB is connected to the UE. After the RN accesses the eNB, the RN operates as if it is an eNB which manages a UE connected thereto. Accordingly, the Un interface is defined as a form including a function of a Uu interface protocol used when the RN operates as if it is a UE, and functions of an X2 Application Part (X2AP) protocol and an S1 Application Part (S1AP) used when the RN operates as if it is an eNB.

Meanwhile, upon communicating with the UE, the RN may share a frequency band used for communication between the eNB and the RN. Namely, an operation in which the Un interface and the Uu interface use the same frequency band is called in-band operation. If the RN performs the in-band operation, a self-interference problem generated during data transmission and reception in the Un and Uu interfaces should be solved. For example, if the RN transmits data to the UE in a subframe in which the eNB transmits data to the RN, the data transmitted to the UE by the RN may function as noise with respect to a receiver of the RN. In addition, interference may occur between a transmitter and a receiver of the RN.

Because of this, RN subframes may be configured in downlink and may be used for backhaul partitioning of a radio frame. The RN subframes are allocated to the RN from an eNB of a relevant cell and the RN may communicate with the eNB only in the RN subframes within the radio frame. The RN may also communicate with UEs in subframes except for the RN subframes within the radio frame. The subframes except for the RN subframes within the radio frame may be referred to as unicast subframes.

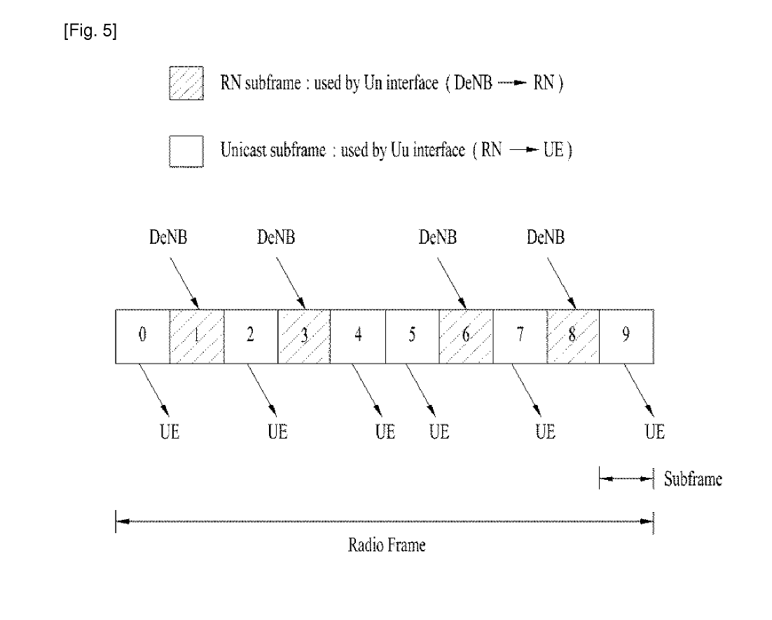

Hereinafter, the structure of a downlink radio frame will be described in brief. FIG. 5 illustrates the structure of a downlink radio frame to which the present invention is applied. Referring to FIG. 5, subframes of numbers 1, 3, 6, and 8 in one downlink radio frame may be allocated to an RN as RN subframes and the RN may attempt to receive messages etc. from an eNB in the allocated RN subframes. Subframes of numbers 0, 2, 4, 5, 7, and 9 except for the RN subframes are unicast subframes and the RN may transmit signals or messages to UEs in the unicast subframes. The number of RN subframes allocated in one radio frame may be determined in consideration of radio resources of the eNB and the number of UEs managed by the RN. The RN subframes may have an allocation structure of a cyclic pattern. As RN subframe allocation information, the length of one cycle and locations of RN subframes within one cycle may be provided. Although FIG. 5 depicts downlink, uplink may be identically applied. In other words, the RN may transmit messages to the eNB in the RN subframes and may receive messages from the UEs in the unicast subframes.

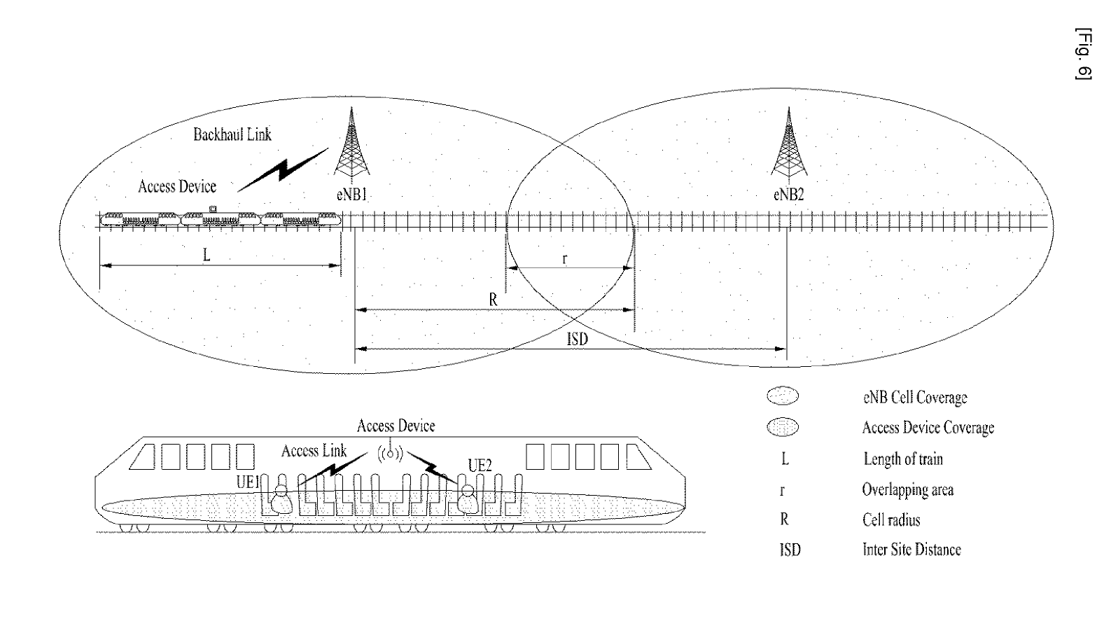

Meanwhile, an RN in motion among RNs is called a mobile RN and an example of using the mobile RN is shown in FIG. 6.

FIG. 6 illustrates an example of using a mobile RN. Referring to FIG. 6, it is assumed that a train moves along a given track at high speed and a user in the train does not move or moves at low speed. Due to characteristics of the train moving at high speed and materials of the train, a severe Doppler shift and signal attenuation may occur in communication between a base station and a UE. This may increase the possibility of handover failure and increase the power consumption of the UE. To overcome such problems, the necessity of an access device between the base station and the UE has emerged and a mobile RN has appeared as an alternative to the access device. As illustrated in FIG. 6, the mobile RN has a wireless backhaul link with the base station and has an access link with UEs. The mobile RN has no major difference from a typical RN except that the mobile RN has mobility.

On the other hand, when the mobile RN performs handover, configuration of RN subframes is required in a relevant neighboring cell of a target base station (target DeNB). In the case where the mobile RN does not know configuration of the RN subframes in the relevant neighboring cell and uses configuration of RN subframes in a serving cell of a source base station (source DeNB), when the mobile RN transmits data to a UE in unicast subframes of the serving cell, this time point may correspond to RN subframes in which the target base station (target DeNB) transmits data to the mobile RN in the corresponding neighboring cell. Accordingly, the mobile RN may not receive data transmitted from the target base station (target DeNB) and may fail to perform handover.

In addition, after execution of handover, although RN subframes may be configured between the mobile RN and the target base station (target DeNB) based on information transmitted by the mobile RN, Quality of Service (QoS) of data which is being transmitted or received may deteriorate due to time delay caused by additional RN subframe configuration.

Accordingly, efficient handover of a mobile RN will be described hereinbelow in detail. It is assumed that the mobile RN performs handover while maintaining an RRC connection with UEs of an RRC_CONNECTED state.

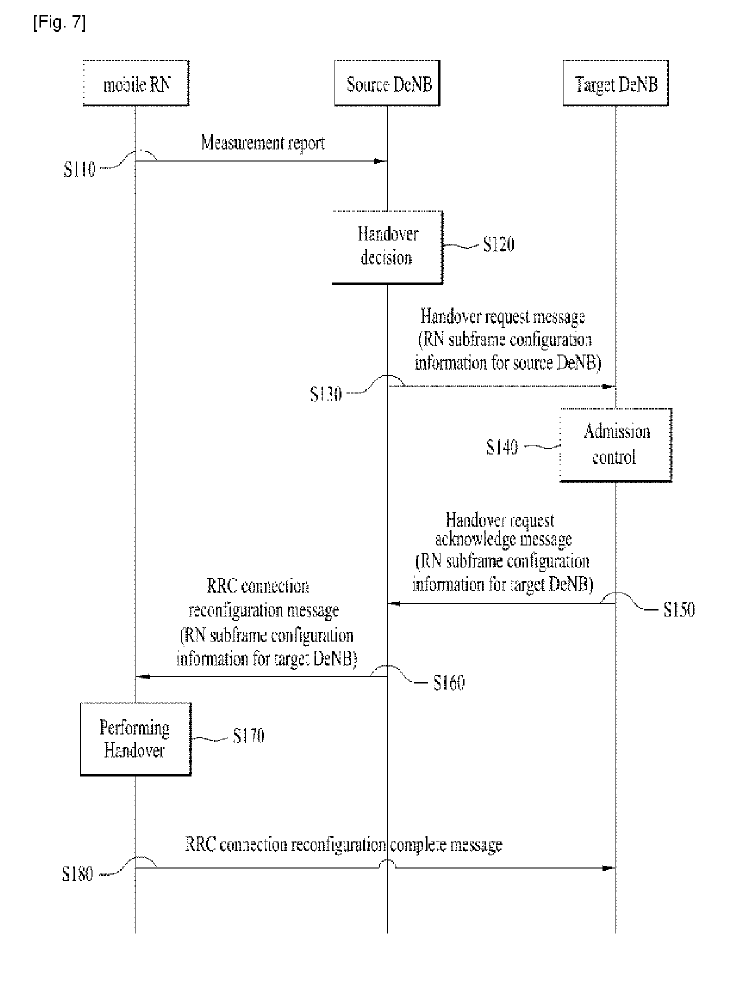

FIG. 7 illustrates a handover process of a mobile RN according to an exemplary embodiment of the present invention. The present embodiment is described based on a mobile RN. However, the present invention is not limited thereto and it is apparent that the present invention is identically applied to mobile devices. Meanwhile, it is assumed in the present embodiment that a target base station (target DeNB) acknowledges a handover request of a mobile RN.

The mobile RN transmits a measurement report to a source base station (source DeNB) (S110). In this case, the mobile RN has maintained an RRC connection with UEs of an RRC_CONNECTED state within a cell of the mobile RN. Therefore, the mobile RN is able to communicate with the UEs even during handover in subframes except for RN subframes which have been used in a serving cell, until new RN subframe configuration information is received. The measurement report may be transmitted to the source base station (source DeNB) from the mobile RN cyclically or by a specific event. Upon receiving the measurement report from the mobile RN, the source base station (source DeNB) may decide whether to perform handover of the mobile RN based on a measurement result about cell quality (S120). For example, if the source base station (source DeNB) receives a measurement report indicating that the quality of a neighboring cell is superior to the quality of a serving cell from the mobile RN, the source base station (source DeNB) may decide to perform handover of the mobile RN to the corresponding neighboring cell.

The source base station (source DeNB) transmits a handover request message including information for handover of the mobile RN to a target base station (target DeNB) of the corresponding neighboring cell (S130). The handover request message is a message transmitted by the source base station (source DeNB) to the target base station (target DeNB) to request preparation of radio resources for handover of the mobile RN and includes configuration information about a connection between the mobile RN and the source base station (source DeNB). The handover request message also includes configuration information about RN subframes between the mobile RN and the source base station (source DeNB). The configuration information about the RN subframes includes the total number of RN subframes used by the mobile RN in the serving cell, RN subframe configuration information indicating which subframes are allocated as RN subframes, and the amount of data buffered by the mobile RN for downlink transmission to a UE. The handover request message may be received using an X2/S1 interface. Upon receiving the handover request message, the target base station (target DeNB) of the neighboring cell decides whether to acknowledge a handover request of the mobile RN (S140). Upon acknowledging the handover request of the mobile RN, the target base station (target DeNB) transmits a handover request acknowledge message including configuration information about RN subframes to be used in the neighboring cell to the source base station (source DeNB) of the serving cell, in consideration of the received configuration information about the RN subframes in the serving cell (S150). The source base station (source DeNB) transmits the configuration information for the RN subframes received from the target base station (target DeNB) to the mobile RN (S160). The configuration information may be transmitted through an RRC connection reconfiguration message. The RRC connection reconfiguration message may include a handover command for the mobile RN. Upon receiving the RRC connection reconfiguration message from the source base station (source DeNB), the mobile RN may perform handover to the target base station (target DeNB) using configuration information included in the received RRC connection reconfiguration message (S170). Upon succeeding in performing handover to the target base station (target DeNB), the mobile RN may transmit an RRC connection reconfiguration complete message corresponding to handover confirmation to the target base station (target DeNB) (S180). On the other hand, the mobile RN may receive a random access response message etc. from the target base station (target DeNB) through RN subframes based on the received configuration information about the RN subframes while performing non-contention based random access for synchronization with the target base station (target DeNB), before transmitting the RRC connection reconfiguration complete message. That is, if the mobile RN receives the configuration information about the RN subframes of the corresponding neighboring cell from the target base station (target DeNB), the mobile RN may immediately receive downlink data transmitted by the target base station (target DeNB) by using the received RN subframes. Simultaneously, the mobile RN may transmit downlink data to a UE within a cell thereof in the other subframes except for new RN subframes.

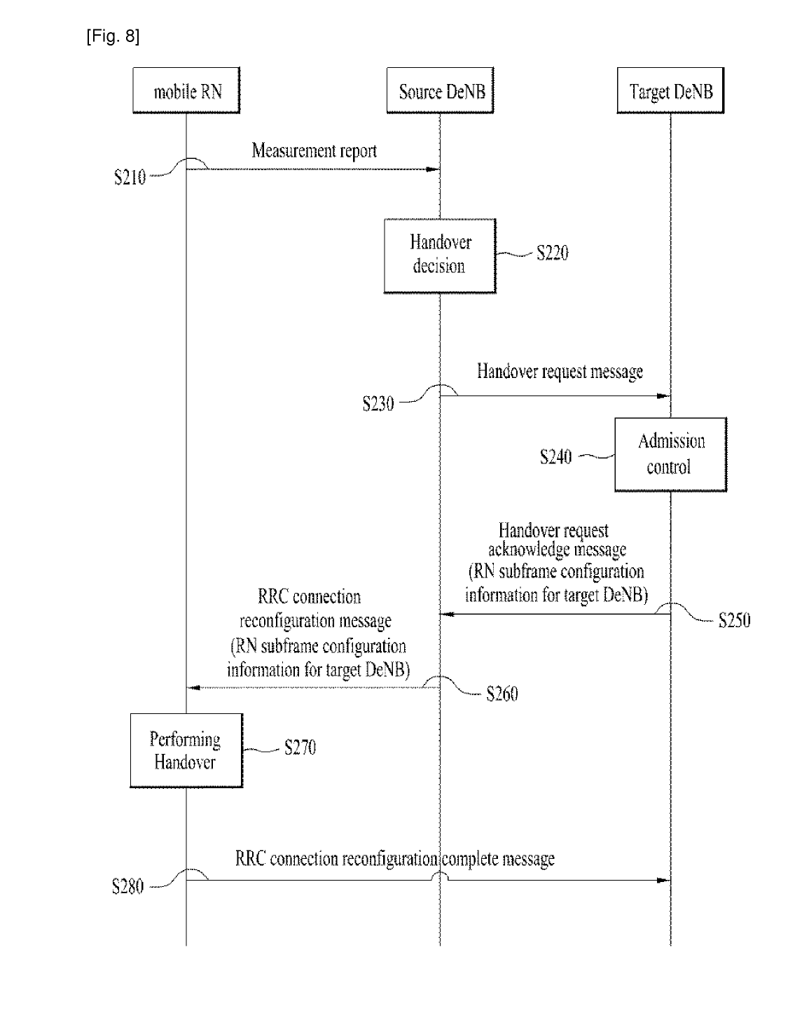

FIG. 8 illustrates a handover process of a mobile RN according to another exemplary embodiment of the present invention. The present embodiment is described based on a mobile RN. However, the present invention is not limited thereto and it is apparent that the present invention is identically applicable to mobile devices. Meanwhile, it is assumed in the present embodiment that a target base station (target DeNB) acknowledges a handover request of a mobile RN.

The mobile RN transmits a measurement report to a source base station (source DeNB) (S210). The measurement report may be transmitted to the source base station (source DeNB) from the mobile RN cyclically or by a specific event. Upon receiving the measurement report from the mobile RN, the source base station (source DeNB) may decide whether to perform handover of the mobile RN based on a measurement result about cell quality (S220). The source base station (source DeNB) transmits a handover request message including information for handover of the mobile RN to a target base station (target DeNB) of a corresponding neighboring cell (S230). Upon receiving the handover request message, the target base station (target DeNB) of the neighboring cell decides whether to acknowledge a handover request of the mobile RN (S240). Upon acknowledging the handover request of the mobile RN, the target base station (target DeNB) transmits a handover request acknowledge message including configuration information about RN subframes to be used in the neighboring cell to the source base station (source DeNB) of a serving cell (S250). The source base station (source DeNB) transmits the configuration information for the RN subframes received from the target base station (target DeNB) to the motile RN (S260). The configuration information may be transmitted through an RRC connection reconfiguration message. The RRC connection reconfiguration message may include a handover command for the mobile RN. Upon receiving the RRC connection reconfiguration message from the source base station (source DeNB), the mobile RN may perform handover to the target base station (target DeNB) using configuration information included in the received RRC connection reconfiguration message (S270). Upon succeeding in performing handover to the target base station (target DeNB), the mobile RN may transmit an RRC connection reconfiguration complete message corresponding to handover confirmation to the target base station (target DeNB) (S280). On the other hand, the mobile RN may receive a random access response message etc. from the target base station (target DeNB) through RN subframes based on the received configuration information about the RN subframes while performing non-contention based random access for synchronization with the target base station (target DeNB), before transmitting the RRC connection reconfiguration complete message.

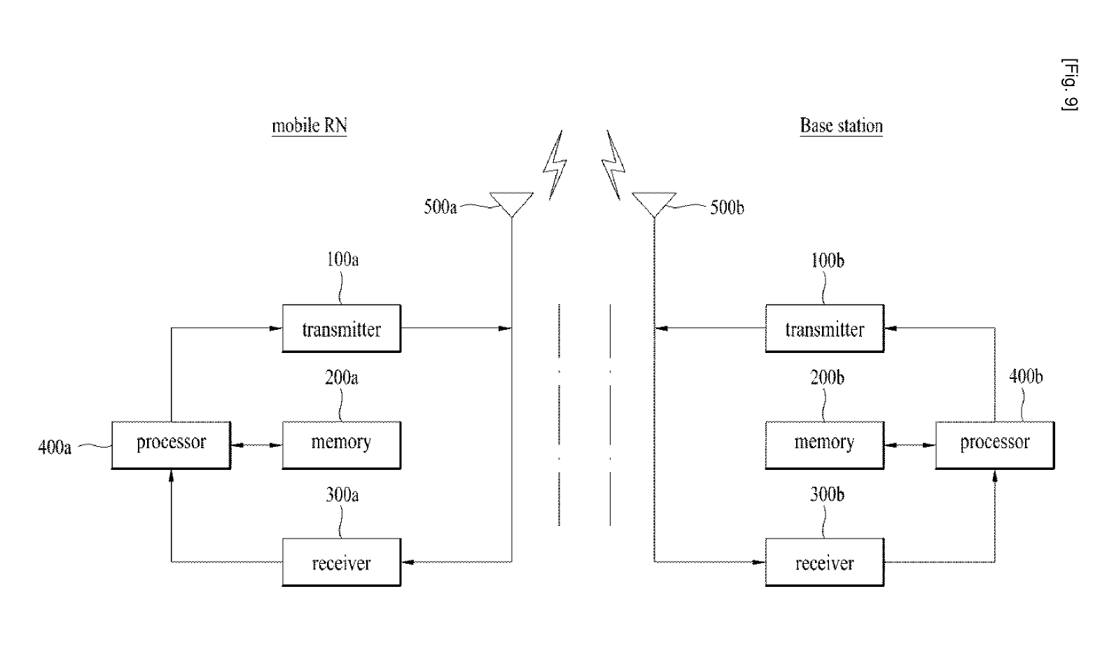

FIG. 9 illustrates the configuration of a mobile device and a base station to which the present invention is applied. The present embodiment is described based on a mobile RN as a mobile device. However, the present invention is not limited thereto and it is apparent that the present invention is identically applicable to other mobile devices (e.g. UEs).

Referring to FIG. 9, a mobile RN and a base station include antennas 500a and 500b for receiving information, data, signals, or messages, transmitters 100a and 100b for transmitting information, data, signals, or messages by controlling the antennas, receivers 300a and 300b for receiving information, data, signals, or messages by controlling the antennas, and memories 200a and 200b for temporarily or permanently storing information associated with communication in a wireless communication system. The mobile RN and the base station further include processors 400a and 400b, respectively, which are adapted to control constituent elements of the transmitters, receivers, and memories.

The transmitter 100a, the receiver 300a, the memory 200a, and the processor 400a in the mobile RN may be configured as independent components on separate chips or two or more thereof may be incorporated into a single chip. Likewise, the transmitter 100b, the receiver 300b, the memory 200b, and the processor 400b in the base station may be configured as independent components on separate chips or two or more thereof may be incorporated into a single chip. The transmitter and the receiver may be incorporated into a single transceiver in the mobile RN or the base station.

The antennas 500a and 500b transmit signals generated from the transmitters 100a and 100b to the outside, or transfer radio signals received from the outside to the receivers 300a and 300b. The antennas 500a and 500b may be referred to as antenna ports, antenna groups, or virtual antennas. Each antenna port may correspond to one logical/physical antenna or may be configured into a combination of a plurality of logical/physical antennas. If the transmitters 100a and 100b and/or the receivers 300a and 300b support a Multiple Input Multiple Output (MIMO) function to transmit and receive data using a plurality of antennas, each of them may be connected to two or more antennas.

The processors 400a and 400b generally control overall operations of the constituent elements or modules of the mobile RN and the base station. Especially, the processors 400a and 400b may carry out a control function for performing the present invention, a Medium Access Control (MAC) frame variable control function based on service characteristics and a propagation environment, a power saving mode function for controlling idle-mode operations, a handover function, and an authentication and encryption function. The processors 400a and 400b may also be referred to as controllers, microcontrollers, microprocessors, microcomputers, etc. The processors 400a and 400b may be configured in hardware, firmware, software, or a combination thereof.

In a hardware configuration, the processors 400a and 400b may be provided with Application Specific Integrated Circuits (ASICs), Digital Signal Processors (DSPs), Digital Signal Processing Devices (DSPDs), Programmable Logic Devices (PLDs), and Field Programmable Gate Arrays (FPGAs), for implementing the present invention.

In a firmware or software configuration, firmware or software may be configured to include a module, a procedure, a function, etc. for performing functions or operations of the present invention. This firmware or software may be provided in the processors 400a and 400b, or may be stored in the memories 200a and 200b and driven by the processors 400a and 400b.

The transmitters 100a and 100b perform predetermined coding and modulation for signals or data, which are scheduled by schedulers connected to the processors 400a and 400b and transmitted to the outside, and then transfer the modulated signals or data to the antennas 500a and 500b. The transmitters 100a and 100b and the receivers 300a and 300b of the mobile RN and the base station may be configured in different manners depending on the procedures of processing transmitted signals and received signals.

The memories 200a and 200b may store programs required for processing and controlling the processors 400a and 400b and temporarily store input and output information. The memories 200a and 200b may be used as buffers. Each of the memories 200a and 200b may be implemented into a flash memory-type storage medium, a hard disk-type storage medium, a multimedia card micro-type storage medium, a card-type memory (e.g. a Secure Digital (SD) or eXtreme Digital (XS) memory), a Random Access Memory (RAM), a Static Random Access Memory (SRAM), a Read-Only Memory (ROM), an Electrically Erasable Programmable Read-Only Memory (EEPROM), a Programmable Read-Only Memory (PROM), a magnetic memory, a magnetic disk, or an optical disk. The mobile RN and the base station may perform methods of the above-described various embodiments with such structures.

The above-described embodiments are combinations of elements and features of the present invention in a predetermined type. Each of the elements or features may be considered selective unless otherwise mentioned. Each element or feature may be practiced without being combined with other elements or features. Further, an embodiment of the present invention may be constructed by combining parts of the elements and/or features. Operation orders described in the embodiments of the present invention may be rearranged. Some elements or features of one embodiment may be included in another embodiment, or may be replaced with corresponding elements or features of another embodiment. Claims which are not explicitly dependent on each other can be combined to provide an embodiment or new claims can be added through amendment after this application is filed.

It is apparent to those skilled in the art that the present invention may be embodied in other specific forms than those set forth herein without departing from the spirit and essential characteristics of the present invention. The above description is therefore to be construed in all aspects as illustrative and not restrictive. The scope of the invention should be determined by reasonable interpretation of the appended claims and all changes coming within the equivalency range of the invention are intended to be within the scope of the invention.

### INDUSTRIAL APPLICABILITY

The method of performing handover according to the present invention is applicable to a variety of wireless communication systems such as a 3GPP LTE/LTE-A system, an IEEE 802 system, etc.

1. A method of performing a handover of a mobile device by a first base station, the method comprising:
transmitting a handover request message to a second base station;
receiving a handover response message in response to the handover request message from the second base station, the handover response message including subframe configuration information related to the second base station; and
performing the handover of the mobile device based on the received handover response message.

2. The method of claim 1, wherein the handover request message includes subframe configuration information related to the first base station, and the subframe configuration information related to the second base station is determined according to the subframe configuration information related to the first base station.

3. The method of claim 1, wherein the subframe configuration information related to the second base station is used by the mobile device in the second base station.

4. The method of claim 2, wherein the subframe configuration information related to the first base station is used by the mobile device in the first base station.

5. The method of claim 1, wherein the mobile device is a mobile relay node (RN).

6. The method of claim 1, wherein the subframe configuration information is RN subframe configuration information.

7. The method of claim 6, wherein the RN subframe configuration information includes information on a number of RN subframes and information on a subframe number of the RN subframes.

8. An apparatus for performing a handover of a mobile device, the apparatus comprising:
a transmitter;
a receiver; and
a processor configured to control the transmitter to transmit a handover request message to a base station, configured to control the receiver to receive a handover response message in response to the handover request message from the base station, the handover response message including subframe configuration information related to the base station, and configured to perform the handover of the mobile device based on the received handover response message.

9. The apparatus of claim 8, wherein the handover request message includes subframe configuration information related to the apparatus, and the subframe configuration information related to the base station is determined according to the subframe configuration information related to the apparatus.

10. The apparatus of claim 8, wherein the subframe configuration information related to the base station is used by the mobile device in the base station.

11. The apparatus of claim 9, wherein the subframe configuration information related to the apparatus is used by the mobile device in the apparatus.

12. The apparatus of claim 8, wherein the mobile device is a mobile relay node (RN).

13. The apparatus of claim 8, wherein the subframe configuration information is RN subframe configuration information.

14. The apparatus of claim 13, wherein the RN subframe configuration information includes information on a number of RN subframes and information on a subframe number of the RN subframes.

15. A method of performing a handover by a mobile device, the method comprising:
receiving a message including subframe configuration information used in a target base station from a serving base station; and
performing a random access procedure with the target base station using the received subframe configuration information.

16. An apparatus for performing a handover, the apparatus comprising:
a transmitter;
a receiver; and
a processor configured to control the receiver to receive a message including subframe configuration information used in a target base station from a serving base station, and configured to perform a random access procedure with the target base station using the received subframe configuration information.
